(19) United States
(12) Patent Application Publication
(10) Pub. No.: US 2012/0213362 A1
(43) Pub. Date: Aug. 23, 2012

(54) Distribution Of Lock Access Data For Electromechanical Locks In An Access Control System

(75) Inventors: Olle Bliding, Halmstad (SE); Mats Älmeby, Halmstad (SE)

(73) Assignee: PHONIRO AB, Halmstad (SE)

(21) Appl. No.: 13/496,594

(22) PCT Filed: Aug. 25, 2010
(86) PCT No.: PCT/SE10/50912

§ 371 Date: Apr. 25, 2012

(30) Foreign Application Priority Data
Sep. 17, 2009 (SE) 0950680-9

(51) Int. Cl. G06F 7/04; H04L 9/00

(52) U.S. Cl. 380/44; 340/5.61

(57) ABSTRACT

A method of updating lock access data for an electromechanical lock is disclosed. The lock is of a type capable of being actuated by a user desiring to open the lock with a key having electronic key data stored therein. Updated lock access data for the lock may be configured by an administrator from a remote site and communicated to the lock using public networks. According to the method, updated lock access data from the remote site for the lock is transmitted over a telecommunication channel to a mobile terminal. The updated lock access data is transmitted from the mobile terminal to the key using short-range wireless communication. When the user attempts to open the lock with the key, the updated lock access data as received from the mobile terminal is forwarded from the key to the lock. The lock verifies that the user is trusted and then accepts the updated lock access data as received from the key.

### FIELD OF THE INVENTION

The present invention relates to access control systems, and more particularly to access control systems with electromechanical locks of the kind which can be actuated by a user who desires to open the lock with a key that stores electronic key data therein.

### BACKGROUND OF THE INVENTION

For quite some time, efforts have been made to replace traditional mechanical locks with various types of electromechanical locks. A problem encountered with such replacement has been how to provide electric power to the electromechanical lock. Conventional approaches have involved an external power supply connected to the lock, or a battery inside either the lock or the associated key.

As an alternative, self-powered electromechanical locks have emerged during the recent years. For instance, WO 2007/068794 discloses an electromechanical lock with an electric power generation mechanism which converts mechanical power, produced by the user when attempting to open the lock with his key, into electric power. In different embodiments of WO 2007/068794, the mechanical power may be produced in different ways, for instance when the user inserts his key into the lock, or turns the key in the lock, or rotates knob of the lock, or presses a handle coupled to the lock. The generated electric power is used by the lock for reading electronic key data from the user's key, issuing an open command based on whether or not the read key data matches a predetermined criterion, and setting the lock in a mechanically openable state by means of an actuator.

In an access control system that involves electromechanical locks and associated keys and is based on the verification of electronic key data, for instance as described in WO 2007/068794, programming of the electromechanical locks as well as the associated keys is required, in order to provide the keys with their respective electronic key data, and the locks with lock access data that defines the access rights to the lock and enables verification of read electronic key data. One trivial possibility would be to perform all programming activities at a central location, such as a factory or a warehouse, upon manufacture or during the early (central) distribution stages for the locks and keys. Clearly, this would be an inferior solution, since an access control system must allow for subsequent (re-)programming of locks and keys to reflect later emerging needs caused e.g. by stolen keys, new users, new access rights for existing users, etc.

WO 2009/040470 discloses a lock administration system for an access control system with self-powered electromechanical locks and associated keys. The integrity of the access control system relies on shared secrets known to both locks and keys. The shared secrets are also stored in one or more physical devices which are called system tokens and which are needed when any lock or key in the access control system is to be programmed. The lock administration system disclosed in WO 2009/040470 therefore has functions for generating a shared secret and a first system token, generating additional system tokens, initially programming a lock, initially programming a key, and re-programming a lock to reflect a change in the access rights to the lock (i.e. a need to update the lock access data stored in the lock).

The last function of the ones listed above is particularly critical in an access control system of some considerable size. When the access control system involves a large number of users/keys and a large number of locks that the users/keys shall or shall not have access to, it is important that the access rights to each individual lock can be updated in a flexible but yet safe manner. In WO 2009/040470, the access control system is illustrated on an overall level in FIG. 1 thereof, and the proposed way to update the access rights to a lock is described in FIG. 4 thereof. Rather than repeating the contents and description of these drawings herein, there will now follow a shortened explanation of them with reference to FIG. 1 of the attached drawings of the present application:

As seen in FIG. 1 of the present application, the prior art access control system according to WO 2009/040470 involves a plurality of self-powered locks 140 mounted to respective doors 150 (only one lock and door being shown in FIG. 1). A user 1a has been given a key 118a, by means of which he may attempt to open the lock 140. The lock 140 is a self-powered electromechanical lock as explained in more detail in aforementioned WO 2007/068794, which harvests the mechanical power produced by the user 1a and converts it into electric power used for operating the lock.

In the prior art system of FIG. 1, the user 1a does however not take any part in updating the access rights of the lock. Instead, an administrator 1b and an installer 1c are involved in a two-stage procedure during which the administrator 1b uses a first programming device 114 and a first client terminal 108 in a first stage, and the installer 1c uses a second programming device 130 and a second client terminal 124 in a second stage. This will now he described in some more detail.

An administration server or ASP (application service provider) server 100 contains server software for causing storage in a database 102 of information related to access rights of locks and keys included in the access control system. However, this information cannot be changed at the administration server itself; instead the administrator 1b uses a client module or software in the first client terminal 108 to log on to the administration server 100 over a public network 104 such as the Internet and command updating of the relevant information. For security reasons, the first client terminal 108 must be connected to the first programming device 114. The first programming device 114 can be used for programming of keys in the access control system. If so is intended, such a key 118b will be inserted into a corresponding opening 118′ in the first programming device 114. For the present situation of updating the access rights of a lock, however, there is no need to insert a key 118b. What is needed, though, is a system token 120 which contains the aforementioned shared secret. The system token 120 is inserted into a corresponding opening 120′ in the first programming device 114.

The client module in the first client terminal 108 provides a user interface for the administrator 1b which allows him to specify the changes to be made to the access rights for the lock 140. The client module sends a “Program Lock” message to the administration server 100. The server 100 stares the received data into the database 102 and sends modified lock access data back to the client module in the first client terminal 108 as a “Send Job” message. The client module receives the message and sends the data as a “Crypt Job” message to the system token 120 connected to the device 114. The system token 120 encrypts the modified lock access data using the shared secret stored therein and sends the encrypted lock access data to the client module as a “Send Crypted Job” message. The client module receives the encrypted data and sends it to the administration server 100 as a “Send Crypted Job” message. The server 100 places the data into a work queue held by the server 100. The work queue contains a list of encrypted lock access data messages which are later to be transmitted to locks. The client module may then log out of the server 100.

The remaining steps of the procedure are performed at the site where the lock 140 is installed, i.e. the premises where the door 150 resides. First, the installer 1c logs in to the administration server 100 from a client module in the second client terminal 124. In the case illustrated in FIG. 1, the second client terminal 124 is a portable computer which uses a cellular link 103 to a base station 105′ of a mobile telecommunications network 105 to establish communication with the administration server 100 via the public network 104. The installer 1c selects, in the user interface presented by the client module, a job available in the work queue held by the server 100 for a lock to be programmed—in this case the lock 140. The work queue replies by sending encrypted lock access data in a message. The client module receives the job and stores it in the memory of the client terminal 124. As previously mentioned, the lock access data contained by the job data is encrypted, so there is no security risk to store the data in the client terminal 124. Next, a system token 136 is inserted into a corresponding opening 136′ in the second programming device 130 coupled to the second client terminal 124. When the client module receives a “Program Lock” command from the installer 1c, it forwards the encrypted lock access data, received from the database 102, to the system token 136. The installer 1c connects the second programming device 130 to the lock 140 to be programmed via a cable 138. The second programming device 130 has its own internal power source (batteries) and serves as a power supply also for the lock 140 via the cable 138 during the lock reprogramming.

When the lock 140 detects that a connection with the second programming device 130 has been established over the cable 138, the lock is configured to authenticate the system token 136 using the shared secret stored in both the system token 136 and the lock 140. After successful authentication, the lock 140 makes a request for updated lock access data from the system token 136. The system token 136 replies by sending the encrypted lock access data previously received from the database 102.

The lock 140 decrypts the received updated lock access data and validates its signature using the shared secret stored in the lock. If the data is valid, the lock 140 updates its access rights by storing the received and decrypted lock access data, and sends an encrypted lock programming status message back to the system token 136 to indicate that the lock 140 has been successfully reprogrammed. The programming device 130 may visually indicate the successful lock reprogramming to the installer 1c by turning on a status LED. Also, the system token 136 sends the encrypted lock programming status to the client module in the second client terminal 124, which forwards it to the work queue 400 held by the server 102.

The lock programming status remains in the work queue until the client module in the first client terminal 108 establishes a session with the server 100. The administrator 1b may use the client module in the first client terminal 108 to check the work queue, verify that the requested reprogramming of the lock 140 has been successfully performed by the installer 1c at the site 150, and ultimately cause an update in the database 102 to duly reflect this.

As can be understood from the explanations above, the procedure for updating the access rights of a lock according to WO 2009/040470 has disadvantages. First, it is a noticeably extensive procedure with many steps involved. Second, and perhaps foremost, it requires an installer 1c to visit the site 150 where the lock 140 is situated, bringing with him the second client terminal 124, the second programming device 130 as well as the system token 136—i.e. no less than three physical devices.

There is consequently a need for a more flexible way of reprogramming a lock in an access control system to have its access rights updated.

### SUMMARY OF THE INVENTION

In view of the above, an objective of the invention is to solve or at least reduce the problems discussed above.

On a conceptual level, the invention is based on a chain of inventive insights. One insight is that the need for an installer (see 1c in FIG. 1) and associated equipment (124, 130, 136 in FIG. 1) in order to update the access rights of an electromechanical lock (self-powered or not) should be eliminated. Instead, lock reprogramming should involve trusted users and their keys (1a and 118a in FIG. 1), since these will have reasons to appear at the lock anyway in the course of everyday life.

Thus, an electromechanical lock in the access control system should be configured to accept updated lock access data from a key belonging to such a trusted user. The key should be provided with a short-range wireless communication interface. When there exists updated lock access data in the database (for instance having been defined by an administrator like 1b in FIG. 1), the administration server should be configured to send updated lock access data over a telecommunications network to a mobile terminal possessed by the trusted user. This may be done in an asynchronous manner; if updated lock access data exists in the database, the updated lock access data could be sent to the mobile terminal at an early point in time, for buffering therein until the trusted user visits the lock site in question. Alternatively, it may be done in a synchronous manner: when the trusted user visits the lock site in question, the key and mobile terminal may cooperate to retrieve the updated lock access data in the database.

When the trusted user visits the lock site and attempts to open the electromechanical lock by using his key, the lock will act to validate the key based on the electronic key data read from the key for the purpose of deciding whether or not to open the lock. In addition to this, the lock should take the opportunity also to receive any existing updated lock access data from the mobile terminal via the key. Thus, the key should receive the buffered updated lock access data over its short-range wireless communication interface from the trusted user's mobile terminal, and in turn allow the lock to receive the updated lock access data from the key. In this regard, the lock should verify that the user is a trusted user before accepting to store the updated lock access data in its memory.

In view of the above, a first aspect of the present invention therefore is a method of updating lock access data for an electromechanical lock capable of being actuated by a user desiring to open the lock with a key having electronic key data stored therein, wherein updated lock access data for said lock may be configured by an administrator from a remote site and communicated to the lock using public networks. The method involves that:

updated lock access data from the remote site for said lock is transmitted over a telecommunication channel to a mobile terminal;

the updated lock access data is transmitted from the mobile terminal to the key using short-range wireless communication;

when the user attempts to open the lock with the key, the updated lock access data as received from the mobile terminal is forwarded from the key to the lock; and

the lock verifies that the user is trusted and then accepts the updated lock access data as received from the key.

Further features of the method according to the first aspect of the invention are defined in the attached dependent claims.

Another aspect of the present invention is an access control system comprising:

a plurality of electromechanical locks, each lock comprising a memory for storing lock access data; and

a plurality of keys, each key comprising a memory for storing electronic key data;

wherein each lock comprises an electronic circuit configured to read the electronic key data of a key possessed by a user, and to issue a lock open command to set the lock in a mechanically open state when the read key data satisfies a pre-determined criterion.

At least one key among said plurality of keys comprises a transceiver for short-range wireless data communication, said transceiver being capable of communicating with a mobile terminal enabled for cellular telecommunication to receive updated lock access data from said mobile terminal.

The electronic circuit of each lock is configured to update its lock access data by:
receiving the updated lock access data from the key;
verifying that said user is a trusted user; and in response
storing the updated lock access data in the memory of the lock.

In an advantageous embodiment, applicable to both the first and the second aspect of the invention, the locks in the access control system are of a type which is driven by electric power produced from mechanical power generated by the user desiring to open the lock with his key.

Other objectives, features and advantages of the present invention will appear from the following detailed disclosure as well as from the drawings.

In particular, it is to be noticed that the access control system, with its locks and keys, according to the second aspect of the invention may have features which are structurally equivalent or corresponding to any of the functional features disclosed for the method according to the first aspect of the invention.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objectives, features and advantages of the present invention, will be better understood through the following illustrative and non-limiting detailed description of embodiments of the present invention, reference being made to the appended drawings in which:

FIG. 1 is a schematic view of an access control system and illustrates a prior art procedure for updating the access rights of a self-powered lock,

FIG. 2 illustrates an access control system and a procedure for updating the access rights of an electromechanical lock according to one embodiment,

FIG. 3 is a block diagram illustrating the main components of a key and lock according to one embodiment,

FIG. 4 illustrates typical memory contents of the key and the lock shown in FIG. 3,

FIG. 5 is a flowchart and signal diagram which in more detail illustrates the procedure for updating the access rights of an electromechanical lock according to one embodiment, and

FIG. 6 is a flowchart and signal diagram which in more detail illustrates the procedure for updating the access rights of an electromechanical lock according to another embodiment.

### DETAILED DESCRIPTION OF EMBODIMENTS

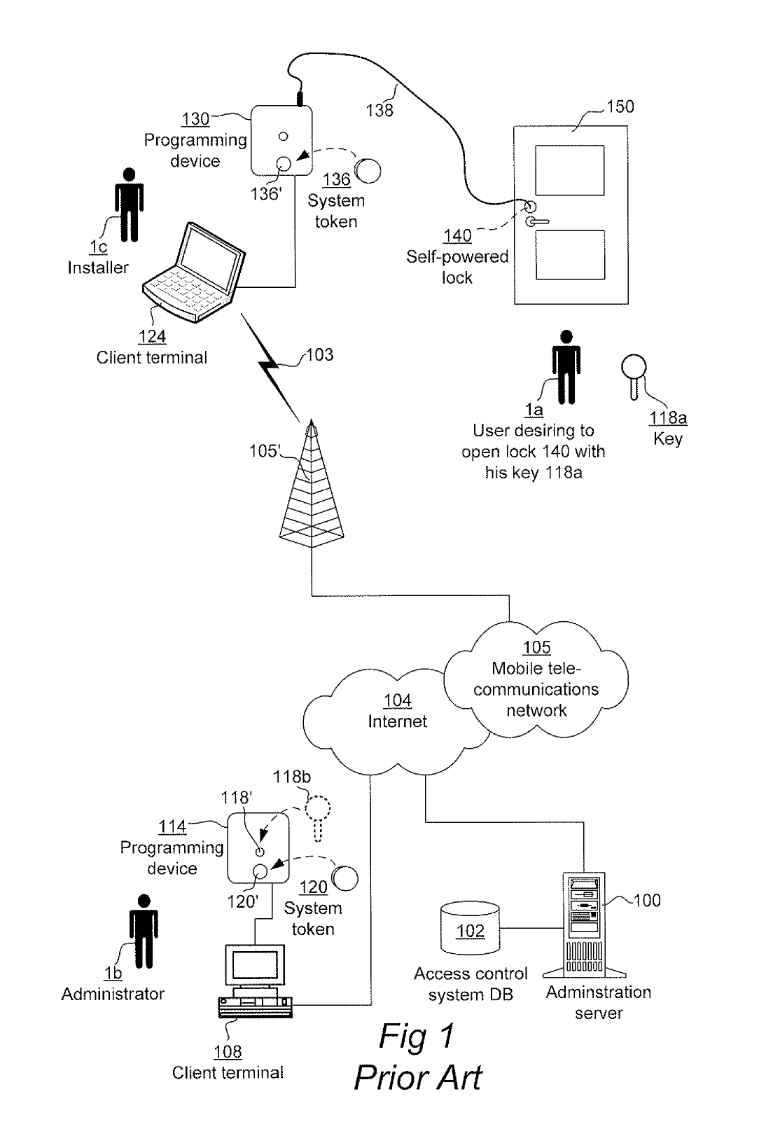

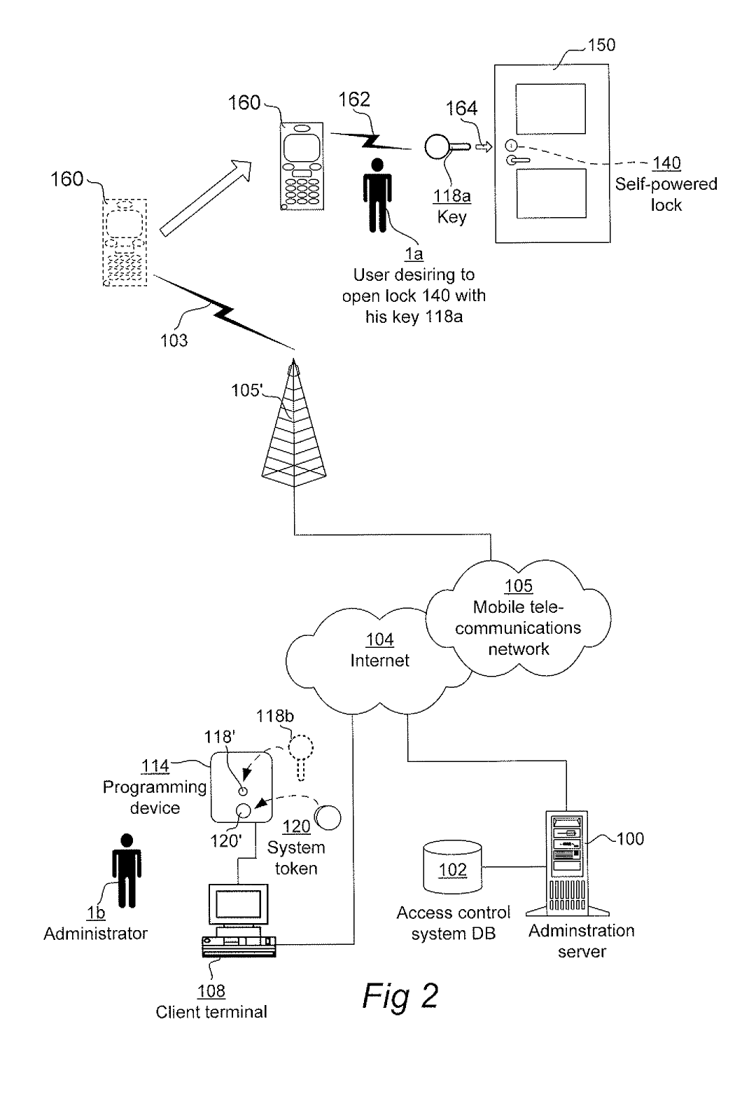

The access control system shown in FIG. 2 serves to illustrate how the approach for updating the access rights of electromechanical locks according to a preferred embodiment differs from the prior art approach previously explained with reference to FIG. 1. Elements in FIG. 2 with the same reference numeral as in FIG. 1 may be similar or even identical to the corresponding elements of FIG. 1 and may, therefore, be similar or even identical to the ones disclosed in the aforementioned WO 2009/040470.

As seen in FIG. 2, the access control system involves a plurality of electromechanical locks 140 mounted to respective doors 150 (only one lock and door being shown in FIG. 2). A user 1a has been given a key 118a, by means of which he may attempt to open the lock 140. In the disclosed embodiment, the lock 140 is a self-powered electromechanical lock, which harvests the mechanical power produced by the user 1a and converts it into electric power used for operating the lock. The mechanisms for such power generation and transformation may, for instance, be any of the alternatives explained in more detail in the aforementioned WO 2007/068794 which is incorporated herewith by reference.

Unlike the prior art system of FIG. 1, the user 1a does indeed take part in the procedure for updating the access rights of the lock 140. In particular, the user 1a is involved by way of a mobile terminal 160 that he possesses—during the second stage of the procedure (i.e. the stage that occurs on-site, at the door 150). The first stage of the procedure may be performed as described for FIG. 1, i.e. by an administrator 1b who uses a first programming device 114, a first client terminal 108 and a system token 120 to request and specify the desired update of access rights of the lock 140 in the remote site (central administration server) 100 and access control system database 102.

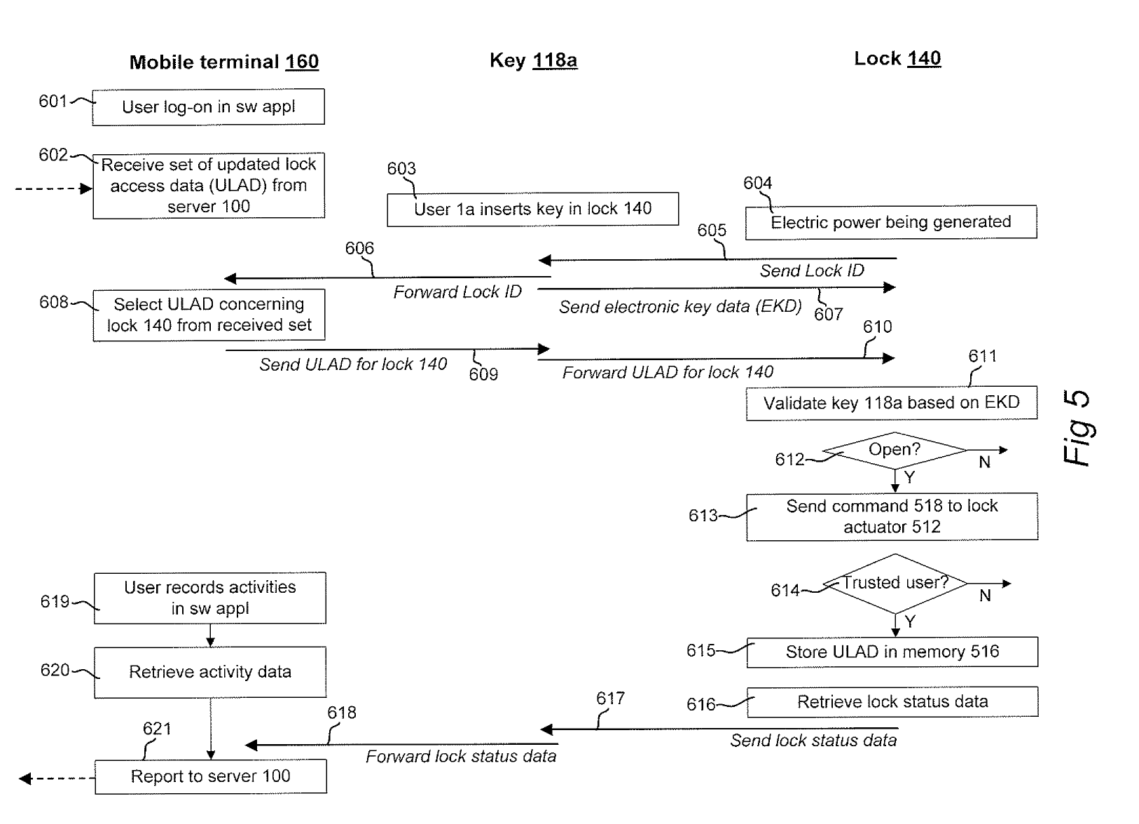

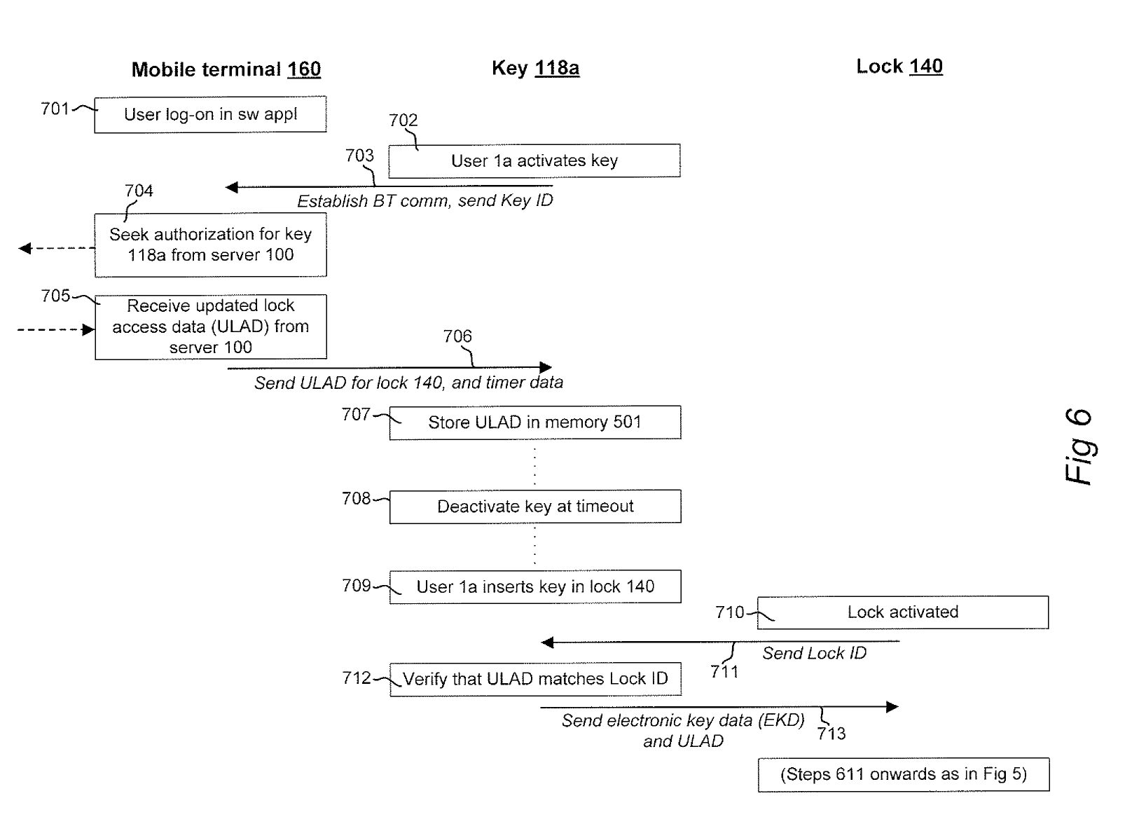

When the administrator 1b has created a programming job concerning the lock 140 in the work queue held by the server 100, the server 100 is configured to communicate the updated lock access data contained in the job to the user's 1a mobile terminal 160 at an appropriate time. This may be performed in different ways, employing different available communication channels over the mobile telecommunications network 105, including but not limited to EDGE, GPRS, HSPA, SMS, MMS and email. In the disclosed embodiment, the mobile terminal 160 comprises a customized software application configured to handle the lock programming procedure from the terminal's point of view. This software application, which will be referred to in some more detail with reference to FIG. 5, may make an inquiry at the administration server 100 for updated lock access data to be received, in a pull-type data transfer operation using for instance an EDGE, GPRS or HSPA channel. This may either occur periodically, or triggered by the user 1a, key 118a or lock 140. Alternatively or additionally, the server 100 itself and/or the administrator 1b may take the initiative and cause transmission of the updated lock access data to the mobile terminal 160 in a push-type data transfer operation. In other embodiments, for instance embodiments where the mobile terminal 160 does not include the customized software application, SMS, MMS or email messaging channels may be used for transferring the updated lock access data to the mobile terminal 160.

The transfer of updated lock access data to the mobile terminal 160 may occur at an early point of time when the mobile terminal 160 is not yet in the neighborhood of the door 150. Once received in the mobile terminal 160, the updated lock access data will then be buffered in the mobile terminal 160 by storing in its local memory, waiting for the user 1a to appear at the door 150. Alternatively, the transfer of updated lock access data to the mobile terminal 160 may occur later when the user is attempting to open the lock 140 with his key 118a.

When the user 1a has appeared at the door 150, he may attempt to open the lock 140 by inserting his key 118a, as seen at 164 in FIG. 2. The lock 140 will seek to validate the key 118a based on electronic key data read from the key for the purpose of deciding whether or not to open the lock 140. In addition to this, there will be an opportunity for the lock 140 also to receive any existing updated lock access data from the mobile terminal via the key. Thus, the updated lock access data will be transferred from the mobile terminal 160 to the key 118a over a short-range wireless communication channel 162, and from the key 118a to the lock 140. The lock 140 will verify that the user 1a is trusted and then accept the updated lock access data by storing it in its local memory. This procedure will later be described in more detail with reference to FIG. 5.

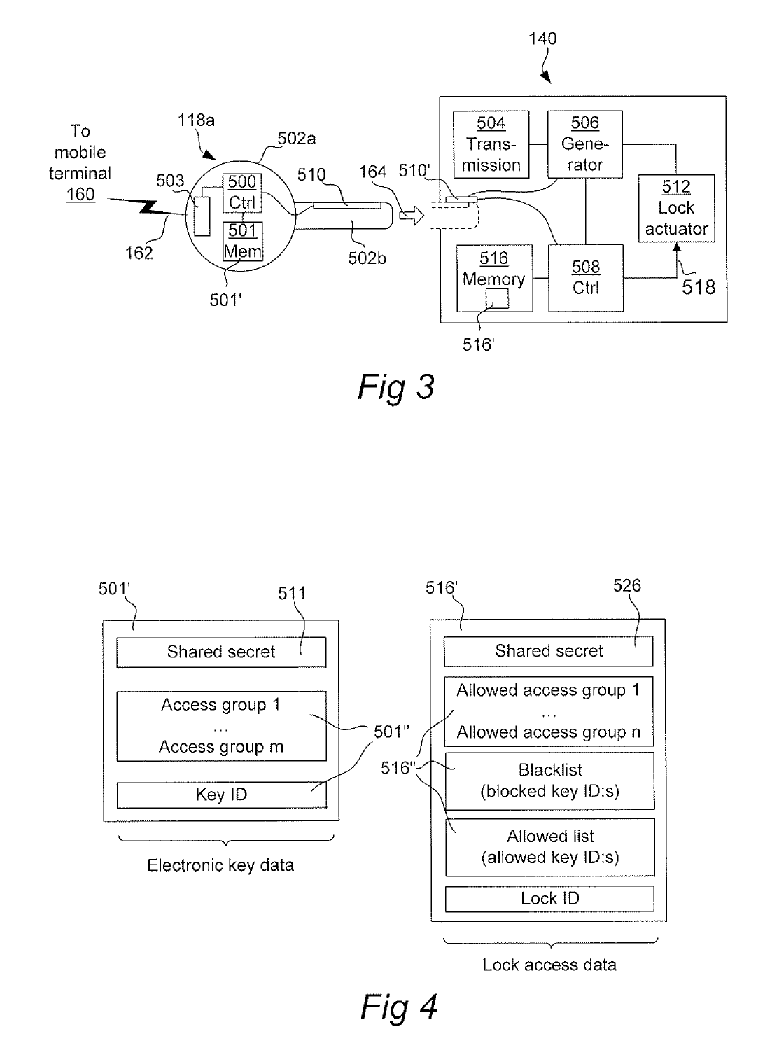

FIG. 3 illustrates the key 118a and the self-powered lock 140 according to one embodiment. The key 118a has a key grip portion 502a and a key blade portion 502b. Unlike a conventional key for a mechanical lock, the key blade portion 502b of the key 118a need not contain a mechanically/physically unique pattern of protrusions or impressions. On the contrary, the key blade portion 502b of the key 118a typically has the same mechanical/physical configuration as other keys in the access control system, and the identification of the key 118a as one that matches the lock 140 lies in electronic key data 501′, which is stored in a local memory 501 in the key grip portion 502a. In addition to the memory 501, the key grip portion 502a comprises an electronic controller circuit 500 and a transceiver 503 for short-range wireless data communication. The transceiver 503 is capable of communicating with the mobile terminal 160 over the wireless link 162, as previously mentioned. In the disclosed embodiment, the transceiver 503 is adapted for communication in accordance with the Bluetooth™ standard, but other means for short-range wireless data communication are also possible, including but not limited to IrDA (Infrared Data Association), WLAN (Wireless Local Area Network) or NFC (Near Field Communication).

The key blade portion 502b has a contact arrangement 510 which is connected to the electronic controller circuit 500 and which serves to establish galvanic contact with a corresponding contact arrangement 510′ in the lock 140, when the user attempts to open the lock 140 by inserting his key 118a in the direction 164. The key grip portion 502a typically contains an internal power source, such as a long-life battery, to supply power to the components 500, 501, 503 of the key 118a. Alternatively, however, if the components are made sufficiently efficient in terms of minimal power consumption, it is envisaged that the components 500, 501, 503 of the key 118a may be driven by electric power produced from the mechanical power generated by the user 1a when actuating the lock with his key. In such a case, the electric power will be supplied from the lock 140 to the key 118a over the contact arrangements 510, 510′.

In the disclosed embodiment, the lock 140 is a self-powered electromechanical lock, which harvests the mechanical power produced by the user 1a and converts it into electric power used for operating the lock. As previously mentioned, the mechanisms for such power generation and transformation have been explained in detail in the aforementioned WO 2007/068794. These mechanisms are represented by transmission 504 and generator 506 in FIG. 3. The lock 140 further has an electronic controller circuit 508 and an associated local memory 516 in which lock access data 516′ is stored. The electronic controller circuit 508 is configured to read the electronic key data 501′ of the key 118a possessed by the user 1a over the contact arrangements 510, 510′. The controller 508 will analyze the read electronic key data 501′with reference to the lock access data 516′ in order to determine whether the key data 501′satisfies a pre-determined criterion, and—if so—to issue a lock open command 518 to a lock actuator 512 so as to set the lock 140 in a mechanically open state. In embodiments where the lock 140 is not self-powered, its components 508, 512, 516 may be driven by the internal power source (e.g. battery) in the key 118a over the contact arrangements 510, 510′.

FIG. 4 illustrates the typical structure and contents of the internal memories 501, 516 of the key 118a and lock 140, respectively, according to one embodiment. The electronic key data 501′ includes at least some data 501″ which allows the lock 140 to determine whether the key 118a is authorized to open the lock 140. These data 501″ may be in the form of one or more access groups, and/or a key ID. Correspondingly, the lock access data 516′ includes at least some data 516″ which supports this determination. These data may be in the form of one or more allowed access groups, a list of allowed key ID:s, and/or a list of blocked key ID:s.

The predetermined criterion, upon which the electronic controller circuit 508 bases its decision as to whether or not to issue the lock open command 518 to the lock actuator 512, may therefore include one or more of the following:

whether the electronic key data 501′/501″ specifies an access group which is included among the allowed access groups according to the lock access data 516′/516″,

whether the electronic key data 501′/501″ specifies a key ID which is included in the list of allowed key ID:s, and

whether the electronic key data 501′/501″ specifies a key ID which is not included in the list of blocked key ID:s.

The disclosed embodiment is applicable to an access control system, the integrity of which relies on shared secrets known to locks and keys in the system, as well as to the central administration server 100. Therefore, the key memory 501 includes a shared secret 511, and so does the lock memory 516 (shared secret 526). By means of the shared secret 511, the electronic controller circuit 500 may calculate a hash upon the electronic key data 501″ to be transmitted to the lock 140, and then send the calculated hash together with the electronic key data 501″ to the lock 140. Alternatively, the hash may be calculated already when the key 118a is programmed (by the administrator 1b using the programming device 114, see FIG. 2), and stored instead of the shared secret itself at 511 in the memory 501. Upon receipt of the electronic key data 501″, the lock 140 may apply its own shared secret 526 to validate the hash by calculating its own hash upon the received data 501″ and confirm that the two hash values match.

FIG. 5 is a flow chart and signaling diagram which explains the interaction between the mobile terminal 160, the key 118a and the lock 140 when the user la attempts to open the lock 140 with his key 118a. The diagram illustrates the activities which are performed in order to cause opening of the lock 140, and also the activities which are essentially simultaneously performed in order to cause updating of the access rights of the lock 140 by transferring updated lock access data from the central administration server (remote site) 100 via the mobile terminal 160 and key 118a to the lock 140.

As previously mentioned, in the disclosed embodiment, the mobile terminal 160 comprises a customized software application configured to handle the lock programming procedure from the terminal's point of view. The software application provides increased security by requiring the user 1a to perform a log-on procedure by entering a user ID and a password in the user interface of the mobile terminal 160 (step 601). When the user 1a has duly logged on, the software application in the mobile terminal 160 is prepared to receive updated lock access data (ULAD) from the server 100 (step 602). As previously mentioned, the transfer of updated lock access data from the server 100 to the mobile terminal 160 may take place at different points in time and be initiated by the mobile terminal 160 or the server 100, depending on implementation.

One advantage of having a customized software application in the mobile terminal 160 is that it can be configured to receive updated lock access data not only destined to the particular lock 140 in question, but potentially destined to other locks in the system as well. This allows for a flexible and powerful distribution scheme, where the administrator 1b can command update of access rights for a plurality of locks at the same time, and send these updates in a set of updated lock access data to a plurality of mobile terminals. Example situations where this may prove handy is in eldercare when new personnel must be given access to the locks to all service flats in a service block, or when a janitor of a multi-storey building has quit his job, and the locks to all apartments in the building must be updated accordingly. Hence, in step 602, the mobile terminal 160 receives a set of updated lock access data and stores it in its local memory.

In step 603, the user 1a inserts his key in the lock 140. In response, the mechanism 504, 506 in the lock 140 generates electric power (step 604). The controller 508 is triggered by this electric power and sends a lock ID to the key 118a (signal 605). Receiving the lock ID in the key 118a triggers two chains of events.

Firstly, the received lock ID tells the electronic controller circuit 501 in the key 118a that it is now time to read the electronic key data 501″ from memory 501 (and either read the associated hash, or generate it using the shared secret 511). The resulting electronic key data is sent in a signal 607 to the Lock 140. In step 611, the electronic controller circuit 508 in the lock 140 validates the key 118a based on the received electronic key data using the hash and shared secret 526, as previously explained. In step 612, the electronic controller circuit 508 will decide if the lock open command 518 can be issued to the lock actuator 512 (step 613) by determining whether or not the received electronic key data satisfies the predetermined criterion, in the manner described above. If steps 612 and 613 are successful, the user 1a may open the door 150.

With reference again to the receipt in the key 118a of the signal 605 with the lock ID, the second chain of events is as follows. The key 118a will forward the received lock ID over the wireless interface 503 to the mobile terminal 160 (step 606). The lock ID allows the software application in the mobile terminal 160 to determine whether there is any data in the set of updated lock access data received from the server 100 that is destined to the particular lock 140. If so, this data is selected in step 608, and sent in a signal 609 to the key 118a. The key 118a will forward the updated lock access data in a signal 610 to the lock 140. Even in applications where only a single piece of updated lock access data (destined to a single particular lock) is transmitted from the server 100 to the mobile terminal, it may still be advantageous for the software application to receive the lock ID, since this will allow the software application to check that the updated lock access data is indeed intended to the particular lock 140, before transmitting it in signal 609 to the key 118a.

In step 614 the electronic controller circuit 508 in the lock 140 verifies that the user 1a is a trusted user. Particulars of this operation will be given later in this document. If step 614 is successful, the received updated lock access data is stored in the memory 516 of the lock 140 in step 615. The exact nature of this operation may vary between different implementations and may furthermore depend on the contents of the updated lock access data compared to the contents of the present lock access data 516′. For instance, the received updated lock access data may entirely replace the present lock access data 516′. Alternatively, it may be appended to or integrated with the latter, so long as there are no conflicts between the access rights defined by the present lock access data 516′ and the access rights defined by the updated lock access data.

An advantage with the customized software application in the mobile terminal is that this allows for reporting of activities recorded by the lock 140 back to the server 100. Therefore, in the disclosed embodiment, the electronic controller circuit 508 in the lock 140 may proceed with an optional step 616 in which lock status data is retrieved from memory 516. Such lock status data may for instance relate to past usage of the lock 140 and may include the key ID:s of past users that have opened or tried to open the lock 140, with the corresponding date and time if the lock 140 has access to such information. The lock status data may alternatively or additionally include a report on successful or failed programming attempts, like the one just performed in the preceding steps 614 and 615. The retrieved lock status data is sent in a signal 617 to the key 118a, which will forward it in a signal 618 to the mobile terminal 160. The mobile terminal 160 may then provide a report to the server 100 in step 621.

In this report, or as separate report, the customized software application in the mobile terminal 160 may also supply the server 100 with activity data representing activities which has been recorded by the user 1a in the mobile terminal 160. To this end, the customized software application in the mobile terminal 160 may allow the user to record such activities whenever applicable (step 619). For instance, in a situation where the user 1a works as a caregiver in eldercare, he may use his mobile terminal 160 to record that he has duly performed his tasks in terms of cleaning, shower, drug administration, etc, with respect to the caretaker behind the door 150. The customized software application will then retrieve the recorded activity data (step 620) and report them to the server 100 (step 621) at an appropriate point in time.

The verification in step 614 of the user 1a as being a trusted user will now be referred to in more detail. As previously explained, the lock 140 needs to verify that the user 1a is trusted before accepting and storing any updated lock access data from him. This may be done in different ways. One alternative is to accept that when the electronic key data 501′ of the key 118a fulfills the predetermined criterion for generating a lock open command 518 in step 612 (i.e. the key 118a is allowed to open the lock 140 according to the present lock access data 516′ in the lock 140), this is also held as evidence that the user 1a is trusted in step 614.

Another alternative is to use the key ID of the key 118a, i.e. to check whether the key ID is included in the present lock access data 516′, e.g. in the list of allowed key ID:s 516″ or included in a separate list of special key ID:s which are specifically trusted when it comes to upgrading of lock access data. The respective keys and users associated with such special key ID:s may be regarded as “ambassadors” in the access control system and have a special privilege in that they are allowed to perform lock programming. In one embodiment, a communication identifier of the transceiver 503 may be used as key ID for such purposes. Advantageously, when the transceiver 503 is a Bluetooth™-transceiver, the communication identifier may be the unique Bluetooth communication address which is assigned to every Bluetooth transceiver chip in conjunction with the manufacture thereof.

It is envisaged that not all keys in the access control system will have to be “ambassador keys” and that other keys than the “ambassador keys” in the access control system need not have the capabilities described above for key 118a. Thus, the access control system may include keys which operate much like the prior art keys found in, for instance, the aforementioned WO 2007/068794. The differentiating nature of the key ID:s of the keys in the access control system may be such that all keys (or a subset of them, i.e. ambassador keys) are made universally unique, or unique within the access control system, or not even unique within the access control system but at least identifying the particular key as falling into one type or category among a number of such types or categories. In the latter case, a user will typically be verified as trusted when his key is identified as falling into said one type of category, representing the status “trusted”.

Still another alternative for the verification of trusted users is instead or additionally to use the corresponding communication identifier of the mobile terminal 160 (e.g. the unique Bluetooth communication address of the Bluetooth™ transceiver in the mobile terminal). To this end, the communication identifier of the mobile terminal 160 may be detected by the key 118a and included in the data sent to the lock 140 in signal 607 or 610.

Yet an alternative is to provide the mobile terminal 160 with a shared secret and to configure the customized software application to generate a hash upon the updated lock access data received in step 602, and to transmit the hash together with the updated lock access data in signal 609. The shared secret may be stored in a secure memory of the mobile terminal, or it may be read from a system token connected to the mobile terminal over an appropriate interface such as NFC, Bluetooth or USB. The key 118a may forward this generated hash to the lock 140 in signal 610. The lock 140 may then use its shared secret 526, calculate an own hash upon the received data in signal 610, and verify that the two hash values match in step 614.

Combinations of two or more of the alternatives set forth above are also conceivable within the scope of the invention.

In an alternative embodiment, the functionality of FIG. 5 has been divided into two main phases—a first phase performed when the user 1a actuates the lock 140 a first time for unlocking the lock and entering the premises behind the door 150, and a second phase performed when the user 1a again actuates the lock 140 for locking the lock and leaving the premises. This alternative embodiment may be advantageous from a power consumption perspective. The electric power that can be harvested from the mechanical work conducted at key actuation is limited and may not be enough for power supplying the entire chain of events in the lock 140 of FIG. 5. Thus, it may be particularly advantageous for embodiments where the key has no own power source but is instead driven by the electric energy generated by the mechanism 504, 506 in the lock 140.

The first phase may for instance include steps/signals 603-609 and 611-613 (user 1a inserts the key 118a on his way in, power is generated, the lock ID is transmitted to the key 118a and forwarded to the mobile terminal 160, the electronic key data is read by the lock 140, the key 118a is validated, the door is rendered openable if appropriate, and the mobile terminal 160 sends the updated lock access data to the key 118a).

The second phase may for instance include steps/signals 603-605, 607, 610, 611 and 614-616 (user 1a inserts the key 118a on his way out, power is generated, the lock ID is transmitted to the key 118a, the electronic key data is read by the lock 140, the key 118a is validated, the updated lock access data is forwarded by the key 118a to the lock 140, the lock verifies that the user 1a is trusted and stores the updated lock access data).

Some further possible developments will now be discussed.

When the user 1a cannot be verified as trusted by the lock 140 in step 614, for instance because he has not previously been an approved ambassador for the lock 140 in question, the lock 140 may be configured to send a challenge code to the key 118a, which may forward it to the mobile terminal 160. The challenge code may be encrypted and may include information that identifies the key 118a. The mobile terminal 160 may send the challenge code further on to the server 100. The server 100 may decrypt the challenge code and check in the database 102 that the key identified by the challenge code is indeed to be regarded as the key of a trusted user. If so, the server 100 may apply a secret algorithm commonly known to the server 100 and the lock 140 to generate a challenge reply. The challenge reply is sent through the mobile terminal and the key 118a back to the lock 140. The lock 140 may use its knowledge about the secret algorithm to verify that the response from the server 100 can be trusted and, therefore, also the key 118a.

In embodiments where the mobile terminal 160 does not contain a customized software application, it is envisaged that information, that will allow the user 1a to be verified as a trusted user even if his key 118a is not previously known to the lock 140, may be communicated from the server 100 via the mobile terminal 160 and the key 118a to the lock 140 in the form of a data object which complies with a file format standard. The data object may be embedded in a digital message, such as SMS, MMS or email, when communicated from the server 100 to the mobile terminal 160. One property of the data object may be the lock ID of the lock 140, and another property may be the key ID of the key 118a, such as the unique Bluetooth communication address of its Bluetooth™ transceiver 503. The file format standard may be a standard for personal data interchange, such as vCard, vCalendar, hCard or iCalendar. Alternatively, the file format standard may for instance be a standard for media data interchange, preferably an image file interchange format standard such as JFIF, Exif or TIFF, or an audio or video file interchange format standard. Reference is made to the applicant's pending patent application No PCT/SE2007/051042, the contents of which is incorporated herein.

FIG. 6 is a flow chart and signaling diagram which explains the interaction between the mobile terminal 160, the key 118a and the lock 140 when the user la attempts to open the lock 140 with his key 118a according to an alternative embodiment. In this alternative embodiment, the activities for transferring updated lock access data from the central administration server (remote site) 100 via the mobile terminal 160 and key 118a to the lock 140 are performed in a somewhat different manner compared to the FIG. 5 embodiment.

In FIG. 6, like in FIG. 5, the user 1a first performs a log-on procedure by entering a user ID and a password in the user interface of the mobile terminal 160 (step 701). The key 118a in the FIG. 6 embodiment is of a type which has an internal power source, e.g. battery, and which in addition may be activated by the user 1a. Such activation may be triggered by the user pressing a button on the housing of the key grip portion 502a, and it may cause awakening of the key's components 500, 501 and 503 from a power-preserving idle or sleep mode. When the user 1a activates the key 118a in step 702, the key 118a uses its transceiver 503 to establish short-range wireless data communication, e.g. Bluetooth™ communication, with the mobile terminal 160 (signal 703). The key 118a may also present its key ID during this procedure.

In step 704, after having been contacted by the key 118a, the mobile terminal 160 may seek for authorization of the key 118a (by way of its key ID) from the server 100. The server 100 may thus check that the key 118a is a key which according to the database 102 may be validly used together with the mobile terminal 160, and/or the user 1a as logged on in the software application. If the authorization fails, the mobile terminal may send a deactivation signal (not shown in FIG. 6) to the key 118a. When receiving this deactivation signal, the controller circuit 500 may cause the key 118a to again enter its idle or sleep mode. Alternatively, as is the case in the disclosed embodiment of FIG. 6, the mobile terminal 160 will respond to the key 118a with timer data (signal 706) indicate that the key 118a may remain active (as a consequence of a successful authorization in step 704). This timer data will then be used by the key 118a to monitor (in step 708) the time it has been activated and cause deactivation of itself, if this time exceeds a timeout period before the user attempts to open the lock with the key (step 709).

When the mobile terminal 160 seeks authorization for the key 118a from the remote server 100, it may also retrieve updated lock access data in step 705. As in FIG. 5, the updated lock access data may pertain to a single lock or a plurality of locks. In FIG. 6, since the user 1a has not yet attempted to open the lock 140, the lock ID has not yet been received from the lock via the key. However, the database 102 may store data that links the key 118a to the particular lock 140 via their key ID and lock ID. Therefore, it is still possible for the mobile terminal 160 to receive from the server 100 in step 705 any updated lock access data that is intended for the particular lock 140 in question, and to send it together with the timer data to the key 118a in the aforementioned signal 706.

In step 707, the key stores the received updated lock access data in its local memory 501, waiting for the user to attempt to open the lock 140 with the key. In step 708, as already mentioned, the key 118a may monitor for a timeout in case the user la fails to attempt to open the lock 140 within the timeout period. To this end, the key 118a may have a real-time clock to facilitate determining whether the timeout period has lapsed. If the key 118a has no such real-time clock, the controller circuit 500 may be adapted to perform some kind of dead reckoning starting with the receipt of signal 706. The timer data received in signal 706 may define the duration of the timeout period and may be configurable from the server 100 for the particular key 118a or collectively for (groups of) keys in the access control system.

If a timeout occurs in step 708, the controller circuit 500 will cause deactivation of the key 118a by causing it to return to its idle or sleep mode. If a timeout does not occur in step 708, a step 709 may follow in which the user attempts to open the lock with the key by inserting the key in the lock. In response, the lock 140 will be activated in step 710. This may involve self-generation of electric power (cf step 604 of FIG. 5), or receipt of electric power from the power source in the key 118a.

In response, the lock 140 may transmit its lock ID in a signal 711 to the key 118a. This will allow the key 118a to verify in step 712 that the updated lock access data (as received in step 705 from the server 100) is intended for the lock 140. After successful verification, the key 118a will send the updated lock access data stored in its memory 501 to the lock 140 in signal 713. In the same signal, or as a separate signal, the key 118a may send its electronic key data to the lock 140.

Based on the received electronic key data and updated lock access data, the lock may then perform steps identical or corresponding to steps and signals 611 through 621 of the FIG. 5 embodiment. Thus, this may involve validating the key 118a based on the electronic key data and accordingly controlling the lock actuator 512, determining whether the user is trusted and accordingly storing the updated lock access data in memory 516, and reporting lock status data to the key 118a, mobile terminal 160 and sever 100.

1. A method of updating lock access data for an electromechanical lock capable of being actuated by a user desiring to open the lock with a key having electronic key data stored therein, wherein updated lock access data for said lock may be configured by an administrator from a remote site and communicated to the lock using public networks, the method comprising:
transmitting updated lock access data for said lock from the remote site over a telecommunication channel to a mobile terminal;
transmitting the updated lock access data from the mobile terminal to the key using short-range wireless communication;
when the user attempts to open the lock with the key, forwarding the updated lock access data, as received from the mobile terminal, forwarded from the key to the lock; and
the lock verifying that the user is trusted and then accepting the updated lock access data as received from the key.

2. The method of claim 1, wherein the lock verifies that the user is trusted by determining that the electronic key data of the key satisfies a predetermined criterion for issuing a lock open command to set the lock in a mechanically open state.

3. The method of claim 1, wherein the lock verifies that the user is trusted by checking whether a key ID of the key is included in lock access data presently stored in a memory of the lock.

4. The method of claim 3, the key having a transceiver for performing said short-range wireless communication with the mobile terminal, wherein the key ID of the key is a unique communication address assigned to said transceiver.

5. The method of claim 1, the mobile terminal having a transceiver for performing said short-range wireless communication with the key, a unique communication address being assigned to said transceiver,
wherein the key detects said unique communication address and transmits it to the lock, and
wherein the lock verifies that the user is trusted by checking whether said unique communication address is included in lock access data presently stored in a memory of the lock.

6. The method of claim 1, further comprising:
providing the mobile terminal with a shared secret;
providing the lock with a shared secret;
generating in the mobile terminal a hash upon the updated lock access data received from the remote site;
transmitting the hash together with the updated lock access data from the mobile terminal to the key using said short-range wireless communication, and from the key to the lock; and
verifying in the lock that the user is trusted by using the hash generated in the mobile terminal to verify that the hash matches a hash calculated upon the received updated lock access data by means of the shared secret in the lock.

7. The method of claim 1, wherein the transmission of the updated lock access data from the mobile terminal to the key using short-range wireless communication occurs when or after the user attempts to open the lock with the key.

8. The method of claim 1, said lock being of a type capable of being driven by energy generated by said user when attempting to open the lock, wherein the lock is driven by said energy for receiving the updated lock access data from the key, for verifying that the user is trusted, and for accepting the updated lock access data.

9. The method of claim 8, wherein also the key is driven by said energy generated by the user for receiving the updated lock access data from the mobile terminal and for forwarding the updated lock access data from the key to the lock.

10. The method of claim 1, the key being provided with an internal power source, wherein the key as well as the lock are driven by energy from said internal power source for receiving the updated lock access data from the mobile terminal in the key, for forwarding the updated lock access data from the key to the lock, for receiving the updated lock access data from the key in the lock, for verifying in the lock that the user is trusted, and for accepting the updated lock access data in the lock.

11. The method of claim 1, further comprising:
when the user attempts to open the lock with the key, transmitting a lock ID of the lock from the lock through the key to the mobile terminal, and
checking in the mobile terminal that the updated lock access data received from the remote site is intended for the lock prior to sending it from the mobile terminal to the key.

12. The method of claim 1, further comprising:
when the user attempts to open the lock with the key, transmitting a lock ID of the lock from the lock through the key to the mobile terminal, and
using in the mobile terminal the lock ID to select, from a set of updated lock access data received from the remote site and destined to a plurality of locks, the updated lock access data which is intended for the lock.

13. The method according to claim 1, further comprising:
when the user attempts to open the lock with the key, transmitting a lock ID of the lock from the lock to the key, and
verifying in the key that the updated lock access data received from the remote site is intended for the lock prior to sending it from the key to the lock.

14. The method of claim 1, further comprising:
retrieving lock status data recorded in the lock; and
communicating the lock status data to the remote site via the key and the mobile terminal.

15. The method of claim 1, the key being provided with an internal power source and being activatable by the user, wherein:
the key, when being activated by the user, establishes said short-range wireless communication with the mobile terminal;
in response, the mobile terminal transmits the updated lock access data, as received from said remote site, to the key;
the key stores the updated lock access data in a local memory thereof; and
when the user attempts to open the lock with the key, the updated lock access data, as stored in said local memory, is sent from the key to the lock.

16. The method of claim 15, wherein
when the short-range wireless communication is established between the key and the mobile terminal, the mobile terminal receives a key ID of the key; and
the mobile terminal uses the key ID to retrieve the updated lock access data from said remote site.

17. The method of claim 15, wherein the key monitors the time it has been activated and causes deactivation of itself if said time exceeds a timeout period before the user attempts to open the lock with the key.

18. An access control system comprising:
a plurality of electromechanical locks, each lock comprising a memory for storing lock access data; and
a plurality of keys, each key comprising a memory for storing electronic key data;
wherein:
each lock comprises an electronic circuit configured to read the electronic key data of a key possessed by a user and to issue a lock open command to set the lock in a mechanically open state when the read key data satisfies a predetermined criterion;
at least one key among said plurality of keys comprises a transceiver for short-range wireless data communication, said transceiver being capable of communicating with a mobile terminal enabled for cellular telecommunication to receive updated lock access data from said mobile terminal; and
the electronic circuit of each lock is configured to update its lock access data by:
receiving the updated lock access data from the key;
verifying that said user is a trusted user; and in response
storing the updated lock access data in the memory of the lock.
